(19) United States
(12) Patent Application Publication
(10) Pub. No.: US 2016/0065653 A1
(43) Pub. Date: Mar. 3, 2016

(54) INTERNET OF THINGS (IOT) DEVICE CONFIGURATION CONSTRUCTION

(71) Applicant: FUJITSU LIMITED, Kawasaki-shi (JP)

(72) Inventors: Wei-Peng CHEN, Fremont, CA (US); Mohammad-Mahdi MOAZZAMI, Mountain View, CA (US); Daisuke MASHIMA, Sunnyvale, CA (US)

(21) Appl. No.: 14/469,402

(22) Filed: Aug. 26, 2014

(51) Int. Cl. H04L 29/08; G06F 3/0484

(52) U.S. Cl. CPC H04L 67/10; G06F 3/0484

(57) ABSTRACT

A method of constructing Internet of Things (JOT) device configurations includes receiving a solution template selection for a device configuration for a particular automated interaction between two or more IOT devices. The method includes determining whether a complete solution template for the device configuration is selected. If so, the method includes deploying the device configuration. If not, the method includes receiving IOT device selections, accessing device capabilities from an IOT database of the selected IOT devices, configuring a network connection between the selected IOT devices, simulating a device configuration using the device capabilities accessed from the IOT database, and determining whether the device configuration is operational based on the simulation. When the device configuration is not operational, the method includes reconfiguring the device configuration to include a replacement IOT device. When the device configuration is operational, the method includes deploying the device configuration.

### FIELD

The embodiments discussed herein are related to Internet of Things (IOT) device configuration.

### BACKGROUND

The Internet of Things (IOT) refers to the interconnection of computing devices (IoT devices). The IOT devices may be uniquely identifiable and may communicate with one or more other IOT devices via computing networks to form device configurations. Multiple protocols, domains, and applications may be implemented in the IOT devices. The multiple protocols, domains, and applications used among the IOT devices may not be compatible with other IOT devices, which may make construction of the device configurations and communications among all IOT devices difficult.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of constructing Internet of Things (IOT) device configurations includes receiving user input effective to select a solution template for a device configuration for a particular automated interaction between two or more IOT devices. The method includes determining whether a complete solution template for the device configuration is selected. In response to the complete solution template being selected, the method includes deploying the device configuration. In response to a partial solution template being selected, the method includes receiving additional user input effective to select two or more IOT devices implemented in the partial solution template, accessing device capabilities of the selected IOT devices from the IOT database, configuring a network connection between the selected IOT devices, simulating a device configurations using the device capabilities accessed from an IOT database for the two or more IOT devices, and based on the simulation, determining whether the device configuration is operational. In response to the device configuration not being operational, the method includes reconfiguring the device configuration to include one or more replacement IOT devices. In response to the device configuration being operational, the method includes deploying the device configuration.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example Internet of Things (IOT) system;

FIG. 2 illustrates an example system server that may be implemented in the IOT system of FIG. 1;

FIG. 3 illustrates an example IOT database that may be implemented in the IOT system of FIG. 1;

FIGS. 4A and 4B are a flow diagram of an example method of constructing device configurations;

FIG. 5 is a flow diagram of an example method of simulating a device configuration;

FIG. 6 is a flow diagram of an example method of deploying a device configuration; and

FIG. 7 is a flow diagram of an example method of confirming a device configuration, arranged in accordance with at least one embodiment described herein.

### DESCRIPTION OF EMBODIMENTS

Technology advances in hardware and communication systems make small devices more powerful and better able to communicate with one another. Internet of Things (IOT) has emerged with these technology advances. IOT creates many useful functions such as automation, surveillance, and the like. However, IOT is intrinsically diverse, fragmented, and sector-specific. Many vendors tend to create independent ecosystems that prohibit incorporation of devices from other vendors. As a result, users with a first type of device may be limited as to the other types of devices that they may use with the first type of device. Accordingly, some embodiments disclosed herein provide an environment to users that enables the construction of device configurations according to their preferences and allows multiple types of devices to communicate and interact. In some embodiments, an IOT database is used in the construction processes of the device configurations. The IOT database may include capabilities of multiple devices, interoperability between the devices, constraints of links between devices, considerations of various applications, etc.

In some systems, a user interface is provided via which multiple devices may be integrated into a device configuration. However, in these systems, a centralized system connects all devices to a central server and/or these systems only support devices that communicate on a limited number of protocols. For instance, some of these systems provide a personal computer (PC)-like organization. The devices are seen as peripherals, and tasks over these devices are seen as applications. Thus, adding a new device is similar to plugging in a peripheral, and adding a task is similar to installing an application.

Some embodiments described herein enable integration of IOT devices that communicate on multiple protocols. Additionally, once incorporated into a device configuration, the devices may communicate peer-to-peer without necessarily passing through a central system. In some embodiments, a configuration controller is provided that constructs a device configuration based on user input. The configuration controller receives user input that provides the preferences of the user with regard to a particular device configuration for a particular automated interaction between two or more IOT devices. The user input may include a selection of a solution template. The solution template may include a template for the particular device configuration. The selected template may include a partial solution template, which enables the user to further specify preferences in the device configuration.

The user may further provide a selection of two or more IOT devices. The configuration controller may access device capabilities from an IOT database for the selected IOT devices and may configure a network connection between the selected IOT devices. In some embodiments, the device configuration may be simulated by the configuration controller to determine whether the device configuration is operational. When the device configuration is not operational, the configuration controller may reconfigure the device configuration to include a replacement IOT device. When the device configuration is operational, the configuration controller may deploy the device configuration. Deploying the device configuration may include communicating configuration parameters to each of the IOT devices as well as any other components included in the configured network connection. This and other embodiments are further described with reference to the appended figures.

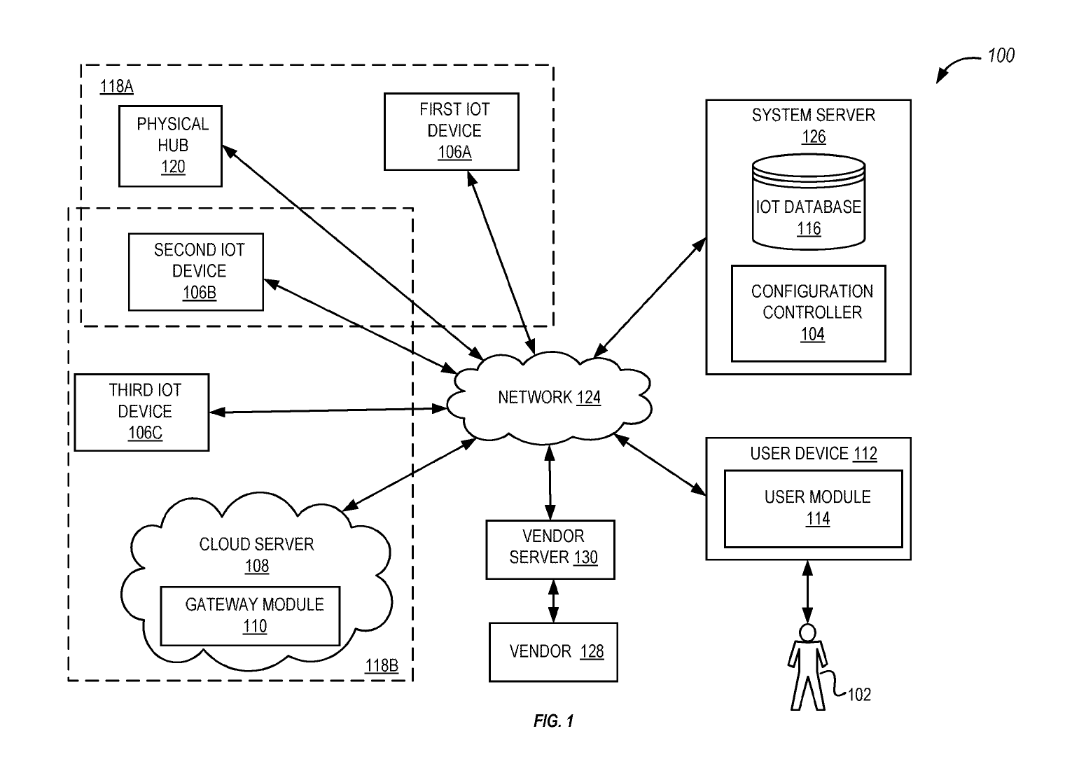

FIG. 1 illustrates an example IOT system 100. In the IOT system 100, a system server 126 may construct IOT device configurations 118A and/or 118B (generally, a device configuration 118 or device configurations 118) based on user input received from a user 102. In some embodiments, the user 102 may interact with a configuration controller 104 to provide the user input used in construction of the device configurations 118.

The device configurations 118 may be constructed for a particular automated interaction between IOT devices 106A-106C (generally, an IOT device or IOT devices), a physical hub 120, a cloud server 108, a gateway module 110, some combination thereof, or some combination of other electronic devices. The particular automated interaction may include any function or any subset of functions of the IOT devices 106 or any subset of the IOT devices 106. For example, the device configuration 118 may be constructed for automated home security, automated comfort adjustment during sleeping, automated energy savings, automated cooking, automated responses to emergencies, automated elderly monitoring or care, automated health care, automated reminders, and automated child care. Some additional details of the home security configuration are provided below.

The particular automated interaction as well as the IOT devices 106 may be determined according to a preference of the user 102. Accordingly, the configuration controller 104 may be configured to receive the preference of the user 102. Based on the user input, the configuration controller 104 may construct the device configuration 118 embodying the preference.

As depicted in FIG. 1, the IOT system 100 may include a system server 126, a user device 112, the IOT devices 106, the physical hub 120, the cloud server 108, and a vendor server 130. Additionally, in the IOT system 100, a vendor 128 may be associated with the vendor server 130 and the user 102 may be associated with the user device 112.

In the IOT system 100 the system server 126, the user device 112, the IOT devices 106, the physical hub 120, the cloud server 108, and the vendor server 130 may communicate via a network 124.

The network 124 may include any communication network configured for communication of signals between any of the components (e.g., 126, 112, 130, 108, 106, and 120) of the IOT system 100. For example, following construction of a first device configuration 118A, a first IOT device 106A, the physical hub 120, and a second IOT device 106B may communicate via the network 124. Thus, a portion of construction of the device configurations 118 may include configuration by the configuration controller 104 of a portion of the network 124. Additionally, during at least some portion of the construction of the device configuration 118, the user device 112 may communicate with the system server 126 via the network 124. Additionally still, the vendor 128 may communicate a vendor solution template to the system server 126 and/or the user device 112 via the network 124.

Accordingly, the network 124 may be wired or wireless. The network 124 may have numerous configurations including a star configuration, a token ring configuration, or another suitable configuration. Furthermore, the network 124 may include a local area network (LAN), a wide area network (WAN) (e.g., the Internet), and/or other interconnected data paths across which multiple devices may communicate. In some embodiments, the network 124 may include a peer-to-peer network. The network 124 may also be coupled to or include portions of a telecommunications network that may enable communication of data in a variety of different communication protocols.

In some embodiments, the network 124 includes or is configured to include a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 124 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the IOT devices 106, physical hubs (e.g., the physical hub 120), cloud sever communication, or gateway modules (e.g., the gateway module 110).

In the IOT system 100, the vendor server 130 may include a hardware server that includes a processor, memory, and communication capabilities. In the illustrated embodiment, the vendor server 130 may be coupled to the network 124 to send and receive information to and from one or more of the user device 112, the system server 126, the IOT devices 106, the physical hub 120, and the cloud server 108 via the network 124.

The vendor server 130 may be associated with the vendor 128. Generally, the vendor 128 may include any entity that provides one or more of the IOT devices 106, the physical hub 120, the cloud server 108, the gateway module 110, communication protocols for use therein, or any combination thereof. For example, in some embodiments, the vendor 128 may include a company that develops and sells one of the IOT devices 106. In other embodiments, the vendor 128 may include an individual that develops and sells a communication protocol for use with one or more of the IOT devices 106.

Included in information and data communicated by the vendor 128 via the vendor server 130 may be the vendor solution template. The vendor solution template may include instructions for a particular automated interaction. For example, the vendor solution template may include a list of the IOT devices 106, the physical hub 120, and the gateway module 110 involved in the particular automated interaction. Additionally, the vendor solution template may include information and capabilities of the IOT devices 106, the physical hub 120, and the gateway module 110 such as interoperability with other IOT devices 106, limitations, and ideal conditions for the particular automated interaction. Some examples of the limitations and ideal condition may include a proximity to one another, line of sight considerations, proximity to other appliances, locations in buildings, and the like.

Additionally, the vendor 128 may communicate with the system server 126, the user device 112, and the gateway module 110 via the vendor server 130 and the network 124. For example, the vendor 128 may communicate patches between communication protocols that may be used in construction of the device configurations 118. Additionally or alternatively, the vendor 128 may communicate ongoing information to the system server 126 and/or the user device 112. For example, the vendor 128 may communicate updates regarding capabilities of the IOT devices 106, information related to new IOT devices, and the like. The system server 126 and/or the user device 112 may accordingly enable construction of the device configurations 118 using updated information.

Additionally, in some circumstances, the vendor 128 may have a policy in which access is allowed to the IOT devices 106 associated with the vendor 128 only through a cloud server (e.g., the cloud server 108) that is also associated with the vendor 128 and/or hosted on the vendor server 130. In these and other circumstances, one or more of the IOT devices 106 not associated with the vendor 128, the gateway module 110, the physical hub 120, or the cloud server 108 may communicate through the vendor server 130 to interact with the IOT devices 106 associated with the vendor 128. Accordingly, one or more of the IOT devices 106 not associated with the vendor 128, the gateway module 110, the physical hub 120, or the cloud server 108 may communicate through the vendor server 130.

The user 102 may include any individual or entity interacting in the IOT system 100. The user 102 may generally wish to implement one or more of the device configurations 118 such that the IOT devices 106 included in the device configuration 118 perform a particular automated interaction.

The user 102 may be associated with the user device 112. For example, the user 102 may own or regularly operate the user device 112 such that data communicated from the user device 112 may be attributed to the user 102 and the data communicated to the user device 112 may be intended for the user 102. The user device 112 may include a computing device that includes a processor, memory, and network communication capabilities. In the IOT system 100, the user device 112 may be coupled to the network 124 for communication with one or more of the system server 126, the IOT devices 106, the physical hub 120, the cloud server 108, the gateway module 110, and the vendor server 130.

For example, the user device 112 may be configured to receive input from the user 102 and convey the received input to the system server 126. In some embodiments, the user device 112 may enable communication with the system server 126 by accessing a browser-based interface that conveys the user input to the system server 126.

Additionally or alternatively, the user device 112 may include a user module 114. The user module 114 may include a web service, a cloud application, a locally stored application, and the like. In some embodiments, the user module 114 may be implemented using hardware including a field-programmable gate array (FPGA) or an application-specific integrated circuit (ASIC). In some other instances, the user module 114 may be implemented using a combination of hardware and software.

The user module 114 may be configured to communicate input received locally at the user device 112 to the system server 126. Additionally, in some embodiments, the user module 114 may provide one or more of the functionalities discussed herein that are attributed to the configuration controller 104. For example, the user module 114 may be configured to enable construction of the device configurations 118 as described herein.

Some examples of the user device 112 may include a laptop computer, a desktop computer, a tablet computer, a mobile telephone, a personal digital assistant (PDA), a mobile e-mail device, a portable game player, a portable music player, a television with one or more processors embedded therein or coupled thereto, or other electronic device capable of accessing and communicating via the network 124.

The physical hub 120 may include any system that connects, wirelessly or via wire, one or more of the IOT devices 106, the user device 112, the system server 126, the cloud server 108, or any combination thereof. In some embodiments, the physical hub 120 may include routing capabilities and/or include a capability to communicate with other physical hubs, routers, or switches that may be included in one of the device configurations 118. The physical hub 120 may include one or more configuration parameters that may dictate which of the IOT devices 106 with which it communicates as well as one or more steps performed to enable communication with the IOT devices 106. The configuration parameters may include, for example, the internet protocol (IP) addresses of one or more of the IOT devices 106, routing instructions based on a sending or receiving device, prioritization information, or any other parameter that may be used in communication in one or more of the device configurations 118.

The cloud server 108 may include any system configured to host an internet-provided service. The cloud server 108 may include a hardware server that includes a processor, memory, and communication capabilities and is accessible via the network 124. The cloud server 108 may provide “virtual” services and/or virtual appliances to the device configurations 118. For example, the cloud server 108 may include the gateway module 110, which may be an example of a virtual appliance.

The gateway module 110 may be accessible via the network 124, and thus physically located remotely. The gateway module 110 may include any system or device that enables communication between the IOT devices 106 using different communication protocols. The gateway module 110 may include other devices that are used in the communication between the IOT devices 106. For example, the gateway module 110 may include a protocol and/or signal translators, an impedance matcher, a rate converter, a fault isolator, and the like. The gateway module 110 may further include one or more configuration parameters that may dictate with which of the IOT devices 106 the gateway module 110 may communicate and one or more steps performed to enable communication with the IOT devices 106, for instance. Although not shown in the embodiment of FIG. 1, the IOT system 100 may also include a physical gateway that may be substantially similar to the gateway module 110 and that may be accessed locally (e.g., non-cloud-based).

In some embodiments, the cloud server 108 may further provide other functions to one of the device configurations 118. For example, the cloud server 108 may provide computing services, aggregation services, access to databases, or any other suitable cloud-based service or system. The cloud server 108 may also include one or more configuration parameters. The configuration parameters may dictate the service provided by the cloud server 108 and/or by the IOT devices 106 with which the cloud server 108 communicates.

The IOT devices 106 may include a computer-based hardware device that includes a processor, memory, and communication capabilities. Each of the IOT devices 106 may be coupled to the network 124 to communicate data with one or more of the user device 112, the system server 126, the vendor server 130, the other IOT devices 106, the cloud server 108, and the physical hub 120. Some examples of the IOT devices 106 include a lightbulb, a lighting system, a door lock, a water heater, a sprinkler system, an air-conditioner, a thermostat, an alarm clock, a window shade, a switch, a smoke alarm, a camera, an egg minder, an electrical outlet, a personal (e.g., piggy) bank, a propane tank, an alarm, a personal proximity sensor, a door sensor, a biometric sensor, a mattress, a mobile device, an automotive sensor, a clock, a cooking device, an electrical breaker, a personal alert sensor, a motion sensor, a calendar, a television, a radio, a radio frequency identification (RFID) tag/RFID detector, a vehicle, an electric vehicle charger, a distributed generator (e.g. solar panel), a distributed energy storage (e.g. battery), and a thermometer.

The device configurations 118 may be constructed by the configuration controller 104 based on input of the user 102 such that the IOT devices 106 communicate one or more specific types of data. For instance, the IOT devices 106 deployed as sensors may communicate a signal representative of a measured condition, the IOT devices 106 deployed to perform a specific operation may be configured to receive a control signal, and the IOT device 106 deployed as a controller may receive a condition upon which operation of an appliance may be varied.

The IOT devices 106 may communicate via one or more communication protocols. For example, in some embodiments, the IOT devices 106 or some subset thereof may be furnished by the vendor 128. The IOT devices 106 may be furnished for a specific function and/or for use with one or more of the other IOT devices 106. The IOT devices 106 furnished by the vendor 128 may communicate via a specific communication protocol.

Some communication protocols may be compatible with other communication protocols. For example, a first protocol from the first IOT device 106A may be translated into a second protocol of the second IOT device 106B. However, other communication protocols may not be compatible with all the other IOT devices 106 and/or with other communication protocols. In circumstances in which two IOT devices 106 communicate using two different but compatible communication protocols, the physical hub 120, the user device 112 with a suitable communication application, the gateway module 110, or some combination may be deployed to enable communication therebetween.

The system server 126 may include a hardware server that includes a processor, memory, and communication capabilities. In the illustrated embodiment, the system server 126 may be coupled to the network 124 for communication with one or more of the user device 112, the vendor server 130, the cloud server 108, the IOT devices 106, and the physical hub 120.

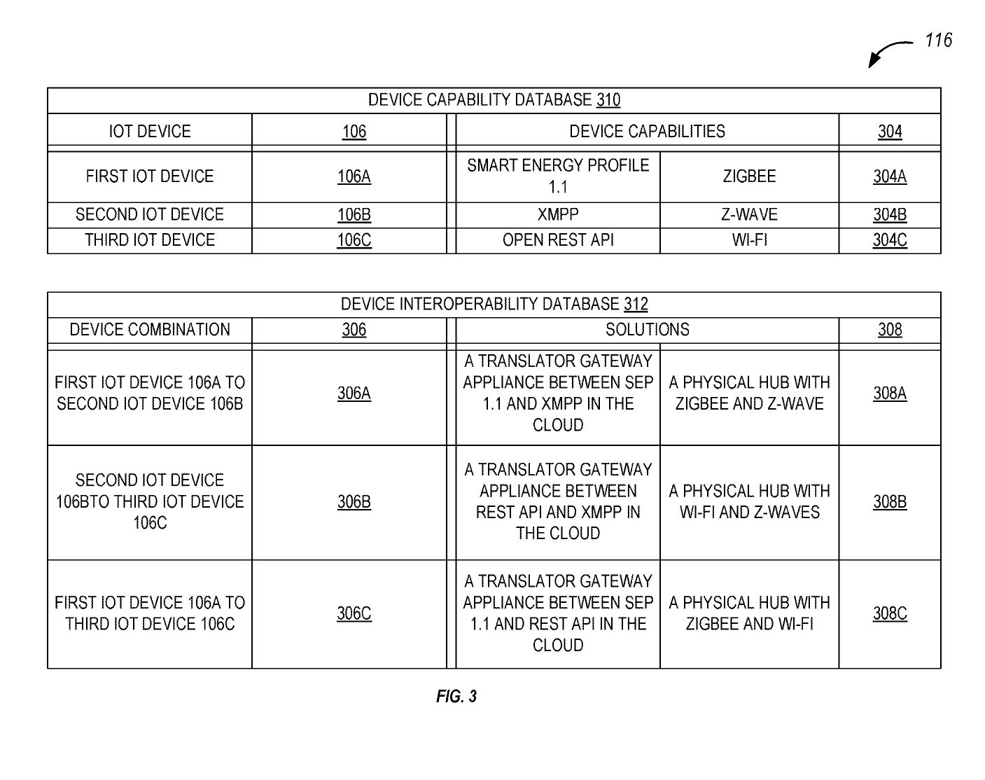

The system server 126 may include an IOT database 116. In general, the IOT database 116 may include capabilities of one or more of the IOT devices 106 and interoperabilities therebetween. For example, with reference to FIG. 3, an example IOT database 116 is depicted. The IOT database 116 includes a device capability database 310 and a device interoperability database 312. The device capability database 310 may include device capabilities 304 for each of the IOT devices 106. For example, in the IOT database 116 of FIG. 3, the first IOT device 106A may include a first device capability 304A. The first device capability 304A includes a capability of communicating using “smart energy profile 1.1” and “ZigBee” communication protocols. In addition, the second IOT device 106B may include a second device capability 304B. The second device capability 304B includes a capability of communicating using “XMPP” and “Z-Wave” communication protocols.

Although not shown in the IOT database 116 of FIG. 3, the device capability database 310 may also include information about one or more application interface protocols (API). For example, the device capability database 310 may include a name of an API, arguments for the API, and the like.

The device interoperability database 312 may include the device interoperability of one or more device combinations 306 of the IOT devices 106. For instance, the device combinations 306 include a first combination 306A of the first IOT device 106A and the second IOT device 106B, a second combination 306B of the second IOT device 106B and a third IOT device 106C, and a third combination 306C of the first IOT device 106A and the third IOT device 106C. For each of the device combinations 306, a communication solution 308 (“solution 308”) may be included in the device interoperability database 312. For example, for the first combination 306A, a first solution 308A may include “a translator gateway appliance between SEP 1.1 and XMPP in the cloud” and/or “a physical hub with ZigBee and Z-wave.” Accordingly, in the example IOT database of FIG. 3, communication between the first IOT device 106A and the second IOT device 106B may utilize a translator gateway appliance between SEP 1.1 and XMPP in the cloud and/or a physical hub with ZigBee and Z-wave.

The IOT database 116 of FIG. 3 includes information related to three IOT devices 106A-106C. In some embodiments, the IOT database 116 may include information related to more than the three IOT devices 106. Additionally, the IOT database 116 of FIG. 3 includes the device capabilities 304, device combinations 306, and the solutions 308. In some embodiments, the IOT database 116 may also include information related to links between one or more of the IOT devices 106, such as constraints.

Referring back to FIG. 1, the system server 126 may include the configuration controller 104. The configuration controller 104 may include code and routines for enabling construction of the device configurations 118. In FIG. 1, the configuration controller 104 is included in the system server 126. In some embodiments, the configuration controller 104 may act in part as a thin-client application that may be stored on the user device 112 (e.g., the user module 114) and in part as components that may be stored on the system server 126. In some embodiments, the configuration controller 104 may be stored in a combination of the system server 126, the physical hub 120, the cloud server 108, the gateway module 110, the user device 112, or any combination thereof. For example, the configuration controller 104 may include a web service, a cloud application, a locally stored application, and the like. In some embodiments, the configuration controller 104 may be implemented using hardware including a field-programmable gate array (FPGA) or an application-specific integrated circuit (ASIC). In some other instances, the configuration controller 104 may be implemented using a combination of hardware and software.

Generally, the configuration controller 104 may be configured by user 102 to construct the device configurations 118 based on input from the user 102. The device configurations 118 may be constructed according to one or more preferences of the user 102 and/or according to a complete solution template. The preferences of the user 102 may include user input that may include a selection of a solution template, a selection of one or more of the IOT devices 106, selection of one or more available parameters of the IOT devices 106, selection of one or more constraints of the IOT devices 106, and the like.

In some embodiments, to initiate construction of the device configuration 118, the user 102 may select a solution template. The solution template may include a complete solution template or a partial solution template. The complete solution template may include all or nearly all information for a particular automated interaction. The complete solution template may be tested, which may enable the configuration controller 104 to simply deploy the device configuration 118 associated with the complete solution template. Additionally or alternatively, the complete solution template may include pre-selected IOT devices 106. The complete solution templates may be marked or otherwise include an indication that allows the configuration controller 104 to identify a solution template as a complete solution template.

Use of the partial solution template may involve additional input from the user 102. For example, the partial solution template may include an outline or an overview of the particular automated interactions between the IOT devices 106. A partial solution template may include some suggested IOT devices 106, some suggested configuration parameters, one or more related functionalities that may be achieved with one or more IOT devices 106, and categories of the IOT devices 106 that may be implemented to achieve the particular automated interaction.

The solution templates may include logic (e.g., branches, if/else statements, and loops) according to one or more use cases such as home automation, energy usage, home security, and the like. Moreover, the solution templates may include one or more conditions included in the logic such as conditions in the branches. Some portions of the logic may be modifiable by the user 102. In addition, the user 102 may be able to change the logic in solution templates, according to her preferences that may input to the configuration controller 104. The vendor solution template may include a complete solution template or a partial solution template.

If the user 102 selects a complete solution template, the configuration controller 104 may deploy the device configuration 118. If, however, the user 102 selects a partial solution template, the user 102 may then select two or more IOT devices 106 for use in the device configuration 118. The configuration controller 104 may then access information stored in the IOT database 116 related to the selected IOT devices 106.

For example, the configuration controller 104 may access the capabilities and/or the device interoperabilities of the IOT devices 106. The configuration controller 104 may then configure a network connection between the selected IOT devices 106 using the partial solution template, the selected IOT devices 106, and information pertaining thereto accessed in the IOT database 116.

Additionally, in circumstances in which a vendor solution template is provided, the configuration controller 104 may access information from the IOT database 116 regarding the IOT devices 106 included in the vendor solution template. The configuration controller 104 may then configure a network connection between the IOT devices 106 included in the vendor solution template using the vendor solution template and information accessed from the IOT database 116. The network connection between the IOT devices 106 may include one or more connections directly between the IOT devices 106. Additionally or alternatively, the network connection may include one or more connections indirectly between the IOT devices 106. For instance, the indirect connections between the IOT devices 106 may be via one or more other components such as the physical hub 120, the gateway module 110, the user device 112, and the cloud server 108.

In some embodiments, the configuration controller 104 may detect whether the network connection is runnable. For example, a solution template may include a condition, that when met by the first IOT device 106A, initiates an action at the second IOT device 106B. The configuration controller 104 may determine another action at the second IOT device 106B in an absence of the condition that may be beneficial to the device configuration 118. Additionally or alternatively, the configuration controller 104 may detect conflicting scenarios in the device configuration 118. For example, a first condition measured at the first IOT device 106A may trigger a first action at the second IOT device 106B and a second condition at the third IOT device 106C may cause a second, conflicting action at the second IOT device 106B. The first action and the second action may be identified as a conflict.

Based on information from the IOT database 116, the configuration controller 104 may simulate the device configuration 118. Based on the simulation, the configuration controller 104 may determine whether the device configuration 118 is operational. In response to the device configuration 118 not being operational, the configuration controller 104 may reconfigure the device configuration 118 to include one or more replacement IOT devices (e.g., 106). In response to the device configuration 118 being operational, the configuration controller 104 may deploy the device configuration 118. The deployment may include communicating configuration parameters to the IOT devices 106 and/or other components of the IOT system included in the device configuration 118.

Additionally, in some embodiments, in response to the device configuration 118 being operational, the configuration controller 104 may display to the user 102 a marketplace. The marketplace may provide a list of physical IOT devices 106 and virtual appliances that may be implemented for the particular automated interaction of the device configuration 118. The marketplace may further enable purchase of the one or more physical IOT devices 106 and the virtual appliances.

In some embodiments, the marketplace may be displayed to the user 102 at other time in constructing the device configuration 118. For example, the marketplace may be displayed during an initial phase of a construction to enable the user 102 to select a solution template. Additionally or alternatively, the marketplace may be displayed after the user 102 selected IOT devices 106. For example, a selection of the IOT devices 106 by the user 102 may be via the marketplace and may be used to configure a network connection.

After deploying the device configuration 118, the configuration controller 104 may confirm the device configuration 118. For instance, the device configuration 118 may be confirmed using a triggering signal. In some embodiments, the triggering signal may be generated or otherwise input by the user 102 to manually emulate a trigging condition of the device configuration 118. For example, the user 102 may heat a room, operate one of the IOT devices 106, and the like.

The configuration controller 104 may also record device input resulting from the triggering condition and/or device input that occurs following deployment of the device configuration 118. The configuration controller 104 may compare the device input with an expected performance based on information in the IOT database 116. When a mismatch exists, the configuration controller 104 may generate a ticket message indicating the mismatch. The generated ticket may be communicated to an administrator that may update or alter the information in the IOT database 116. The information in the IOT database 116 may be updated to reflect the mismatch.

In some embodiments, the configuration controller 104 may include and/or provide a user interface in which the user 102 communicates the user input. The user interface may include a drag-and-drop input, an interactive map of a residence or a location, a right mouse click functionality to configure an available parameter, a pop-up menu to configure an available parameter, a selection of a constraint from a drop-down menu, a programming language-like text-based input (which may be sophisticated users), some combination thereof, or any other suitable user input.

In the IOT system 100, there are two device configurations 118. In other embodiments, the IOT system 100 may include multiple device configurations 118. For example, an example of the device configuration 118 may include a home security configuration. In the home security configuration, the IOT device 106 may include a door sensor, another IOT device 106 may include a camera, and the cloud server 108 may be implemented to provide a facial recognition service. When an individual triggers the door sensor, the camera may be triggered. A photograph of the individual may be communicated to the facial recognition service, which may determine an identity of the individual. If the individual is identified as an intruder, then the facial recognition service may communicate a message to an owner on the user device 112 and/or to a neighbor at a computing device. If the individual is identified as the owner, a setting may be changed to indicate the owner is home, which may cease the door sensor triggering the camera. Additionally, the setting may initiate other IOT devices such as a media recorder or a sprinkler system.

In the context of the home security configuration, the configuration controller 104 may be configured to receive user input from the user 102. The input may include a selection of a sensor template such as a “security” template. In circumstances in which the security template includes a partial solution template, after a selection of the security template, the user 102 may then select the door sensor, the camera, the facial recognition service, the neighbor, the type of alert, provide a photograph of herself for use by the facial recognition service, etc. The configuration controller 104 may simulate a device configuration for the particular automated interaction (e.g., an intruder entering a home and the owner entering the home) between the door sensor, the camera, the facial recognition sensor, etc. using capabilities accessed from the IOT database 116 for the camera, the door sensor, the facial recognition, and the components involved in the messages.

Based on the simulation, the configuration controller 104 may determine whether the home security configuration is operational. In response to the device configuration not being operational, the configuration controller 104 may reconfigure the home security configuration to include one or more replacement IOT devices. For example, if the camera is not capable of communicating a photograph to the facial recognition server, then the configuration controller 104 may communicate a message suggesting another camera or type of camera. In response to the home security configuration being operational or in response to the security template including a complete solution template, the configuration controller 104 may deploy the home security configuration. For example, the configuration controller 104 may communicate the configuration parameters to each of the door sensor, the camera, the facial recognition service, and the components included in the messaging. The user 102 may then generate a triggering signal by entering the home through the door and then having another person entering the home. Based on data resulting from the trigging signals, the configuration controller 104 may confirm the home security configuration.

Another example of the device configuration 118 may include a comfort adjustment configuration. In the comfort adjustment configuration, the IOT devices 106 may include a biometric sensor, an analytics service, a thermostat, and a mattress adjustment system. When a measured biometric condition of an individual triggers a setting in the analytics service, the thermostat may adjust a temperature of a room or the mattress adjustment system may adjust a firmness of the mattress. The biometric sensor may then communicate a signal to the analytics service, which may indicate whether the adjustments improve the individual's sleep.

In the context of the comfort adjustment configuration, the configuration controller 104 may be configured to receive user input from the user 102. The input may include a selection of a sensor template such as a “comfort” template. In circumstances in which the comfort template includes a partial solution template, after a selection of the comfort template, the user 102 may then select the thermostat, the biometric sensor, the analytics service, and the mattress adjustment system. The configuration controller 104 may simulate a device configuration for the particular automated interaction (e.g., a temperature being too high or the bed being too hard) between the selected IOT devices using capabilities accessed from the IOT database 116.

Based on the simulation, the configuration controller 104 may determine whether the comfort adjustment configuration is operational. In response to the comfort adjustment configuration not being operational, the configuration controller 104 may reconfigure the comfort adjustment configuration to include one or more replacement IOT devices (e.g., another type of thermostat). In response to the comfort adjustment configuration being operational or in response to the comfort template including a complete solution template, the configuration controller 104 may deploy the comfort adjustment configuration. For example, the configuration controller 104 may communicate the configuration parameters to each of the IOT devices 106. The user 102 may then generate a triggering signal by heating up the room, attaching the biometric sensor while she is awake, etc. Based on data resulting from the trigging signals, the configuration controller 104 may confirm the comfort adjustment configuration.

Another example of the device configuration 118 may include an energy saving configuration. In the energy saving configuration, the IOT devices 106 may include appliances (e.g., a television) and the user device 112. When an individual leaves her home with the appliance operating, a message may be communicated to the user device 112 and the appliance may be turned off remotely.

In the context of the energy saving configuration, the input may include a selection of a sensor template such as an “energy saving” template. In circumstances in which the energy saving template includes a partial solution template, after a selection of the energy saving template, the user 102 may then select the appliance and the user device 112. The configuration controller 104 may simulate a device configuration for the particular automated interaction (e.g., the individual leaving with the appliance operational) between the selected IOT devices 106 using capabilities accessed from the IOT database 116. Based on the simulation, the configuration controller 104 may determine whether the energy saving configuration is operational as discussed above and communicate configuration parameters to the user device 112 and the appliance.

Modifications, additions, or omissions may be made to the IOT system 100 without departing from the scope of the present disclosure. For example, while FIG. 1 depicts one user device 112 associated with one user 102, three IOT devices 106, one physical hub 120, one cloud server 108, one vendor server 130, two device configurations 118, one gateway module 110, and one system server 126, the present disclosure applies to a IOT system architecture having one or more user devices 112 associated with one or more users 102, one or more IOT devices 106, one or more physical hubs 120, one or more cloud servers 108, one or more vendor servers 130, one or more device configurations 118, one or more gateway modules 110, one or more system servers 126, or any combination thereof. Moreover, the separation of various components and servers in the embodiments described herein is not meant to indicate that the separation occurs in all embodiments. Moreover, it may be understood with the benefit of this disclosure that the described components and servers may generally be integrated together in a single component or server or separated into multiple components or servers.

In the IOT system 100, memory may include a non-transitory memory that stores data for providing the functionality described herein. The memory may be included in storage that may be a dynamic random access memory (DRAM) device, a static random access memory (SRAM) device, flash memory, or some other memory devices. In some embodiments, the storage also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

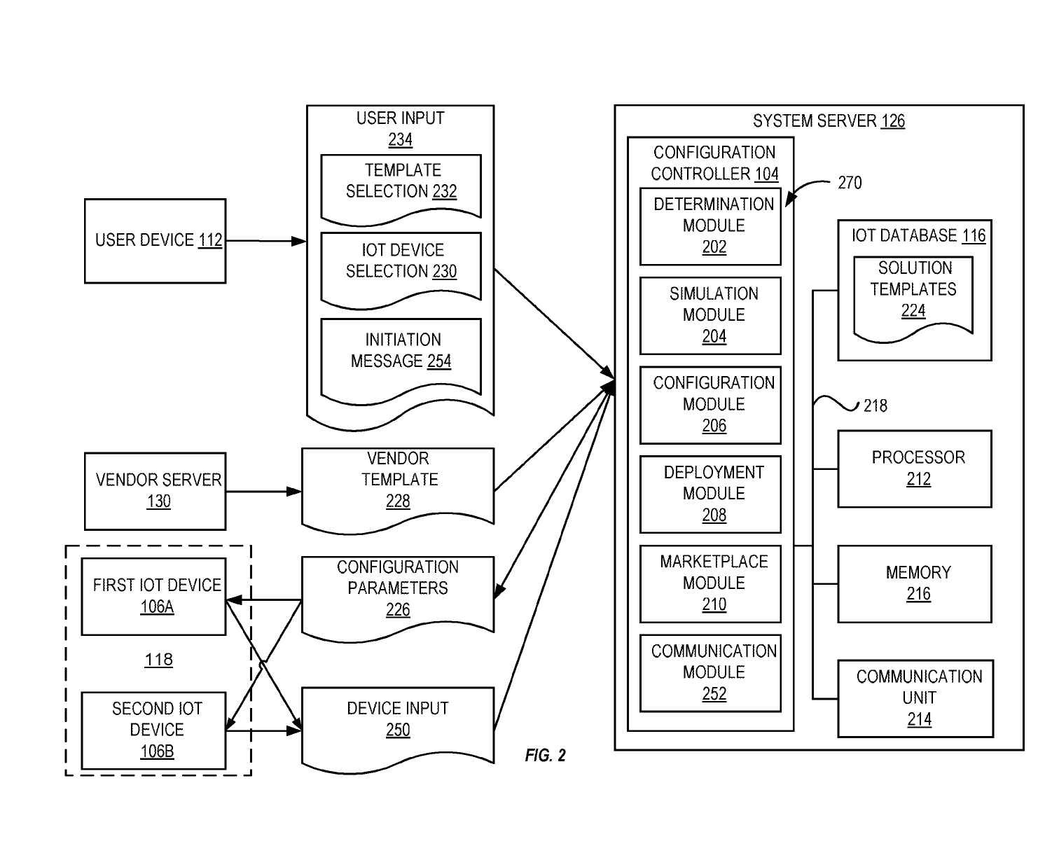

FIG. 2 is a block diagram of an example of the system server 126 that includes an example of the configuration controller 104, the IOT database 116, a processor 212, a memory 216, and a communication unit 214. The components (e.g., 104, 116, 212, 214, and 216) of the system server 126 may be communicatively coupled by a bus 218.

In FIG. 2, the configuration controller 104 is included in the system server 126. In other embodiments, the configuration controller 104 or some portion thereof or functionality attributed thereto may be included in the user device 112 or one or more other components of the IOT system 100 of FIG. 1.

The processor 212 may include an arithmetic logic unit (ALU), a microprocessor, a general-purpose controller, or some other processor array configured to perform computations. The processor 212 may be coupled to the bus 218 for communication with the other components. The processor 212 generally processes data signals and may include various computing architectures including a complex instruction set computer (CISC) architecture, a reduced instruction set computer (RISC) architecture, or an architecture implementing a combination of instruction sets. Although FIG. 2 includes a single processor 212, multiple processors may be included in the system server 126. Other processors, operating systems, sensors, displays, and physical configurations may be possible.

The memory 216 may be configured to store instructions and/or data that may be executed by the processor 212. The memory 216 may be coupled to the bus 218 for communication with the other components. The instructions and/or data may include code for performing the techniques or methods described herein. The memory 216 may be a DRAM device, an SRAM device, flash memory, or some other memory device. In some embodiments, the memory 216 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The communication unit 214 may be configured to transmit and receive data to and from the user device 112, the vendor server 130, and the IOT devices 106. The communication unit 214 may be coupled to the bus 218. In some embodiments, the communication unit 214 includes a port for direct physical connection to the network 124 of FIG. 1 or to another communication channel. For example, the communication unit 214 may include a USB, SD, CAT-5, or similar port for wired communication with the components of the IOT system 100. In some embodiments, the communication unit 214 includes a wireless transceiver for exchanging data via communication channels using one or more wireless communication methods, including IEEE 802.11, IEEE 802.15, IEEE 802.16, BLUETOOTH®, ZigBee, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MQTT-S, CoAP, REST API, XMPP, or another suitable wired and/or wireless communication method.

In some embodiments, the communication unit 214 includes a cellular communications transceiver for sending and receiving data over a cellular communications network including via SMS, MMS, HTTP, direct data connection, WAP, e-mail, or another suitable type of electronic communication. In some embodiments, the communication unit 214 includes a wired port and a wireless transceiver. The communication unit 214 may also provide other conventional connections to the network 124 of FIG. 1 for distribution of files and/or media objects using standard network protocols including TCP/IP, HTTP, HTTPS, and SMTP, etc.

In the embodiment of FIG. 2, the configuration controller 104 may include a determination module 202, a simulation module 204, a configuration module 206, a deployment module 208, a communication module 252, and a marketplace module 210 (collectively, IOT modules 270). Each of the IOT modules 270 may be implemented as software including one or more routines configured to perform one or more operations. The IOT modules 270 may include a set of instructions executable by the processor 212 to provide the functionality described below. In some instances, the IOT modules 270 may be stored in or at least temporarily loaded into the memory 216 of the system server 126 and may be accessible and executable by the processor 212. One or more of the IOT modules 270 may be adapted for cooperation and communication with the processor 212, and components of the system server 126 via the bus 218.

The communication module 252 may be configured to handle communications between the configuration controller 104 and other components of the system server 126 (e.g., 116, 212, 214, 216, and 218). The communication module 252 may be configured to send and receive data, via the communication unit 214, to and from one or more of the user devices 112, the vendor server 130, and the IOT devices 106. In some instances, the communication module 252 may cooperate with the other modules (e.g., 202, 204, 206, 208, and 210) to receive and/or forward, via the communication unit 214, data from the components of the IOT system 100 of FIG. 1.

In some embodiments, the communication module 252 may be configured to receive or access a vendor solution template 228 (vendor template 228 in FIG. 2) from the vendor server 130. The vendor solution template 228 may include one or more IOT devices (e.g., the IOT devices 106) that may be suitable or suggested for a particular automated interaction. Additionally, the vendor solution template 228 may include information (e.g., configuration parameters 226, constraints limitations of the IOT devices) pertaining to the particular automated interaction. The communication module 252 may communicate the vendor solution template 228 to the IOT database 116 and/or the determination module 202. The vendor solution template 228 may include a complete solution template or a partial solution template.

The communication module 252 also may be configured to receive user input 234 from the user device 112. The user input 234 may include a template selection 232 and/or an IOT device selection 230. The communication module 252 may communicate the user input 234 to the determination module 202.

The template selection 232 may reference a complete solution template or a partial solution template (solution templates 224 in FIG. 2) that may be stored in the IOT database 116 or another suitable location. The solution templates 224 may include information pertaining to a particular automated interaction of one or more of the IOT devices 106.

To construct the device configuration 118 or any device configuration as described herein, the determination module 202 may determine whether a complete solution template is selected for the device configuration 118. For example, the determination module 202 may determine whether a user using the user device 112 has selected to use the vendor solution template 228 that is a complete solution template or has selected one of the solution templates 224 that is a complete solution template.

In response to the determination module 202 determining that a complete solution template is selected, the determination module 202 may communicate a signal indicating such to the deployment module 208. The deployment module 208 may be configured to deploy the device configuration 118 according to the complete solution template.

In response to the selection of a partial solution template, the communication module 252 may receive the user input 234 effective to select two or more IOT devices 106 (e.g., the IOT device selection 230). By selecting the IOT devices 106 and the partial solution template, a user may be indicating that the selected IOT devices 106 are to be implemented in the partial solution template. The determination module 202 may communicate the user input 234 to the configuration module 206. The configuration module 206 may access device capabilities from the IOT database 116. Based on the accessed device capabilities, the configuration module 206 may configure a network connection between the selected IOT devices 106.

In some embodiments, to configure the network connection, the configuration module 206 may determine whether and how the IOT devices 106 are able to communicate with one another. When the IOT devices 106 may not communicate with one another, the network connection may be configured to include a physical hub and/or gateway such as a gateway module or a physical gateway. For example, in response to the IOT devices 106 being able to communicate, the configuration module 206 may generate parameters enabling communication between the selected IOT devices 106. In response to the selected IOT devices 106 not being able to communicate, the configuration module 206 may generate parameters enabling communication between the IOT devices 106 via a physical hub or a gateway module.

In some embodiments, one or more portions of the network connection may be stored in the IOT database 116. In these and other embodiments, the configuration module 206 may access one or more of the portions from the IOT database 116 and combine the portions to configure the network connection. Based on the information from the IOT database 116, the configuration module 206 may generate the configuration parameters 226 that may be communicated to the IOT devices 106 and/or the physical hubs and gateways. For example, with combined reference to FIGS. 2 and 3, the configuration module 206 may access the device capabilities 304 of one or more of the IOT databases 116. Based on the particular IOT devices 106 and an arrangement of the IOT devices implemented in the device configuration 118, the configuration module 206 accesses the device capabilities 304 that may indicate whether the IOT devices 106 may communicate with one another. In circumstances in which the IOT devices 106 may not communicate with one another, the configuration module 206 may access one or more of the solutions 308, which may include information regarding a particular portion of the network connection between two or more of the IOT devices 106. The configuration module 206 may generate the configuration parameters 226 enabling communication between the IOT devices 106 based on the device capabilities 304 and/or the solutions 308.

The configuration module 206 may communicate a signal representative of the network connection to the simulation module 204. The simulation module 204 may be configured to simulate the device configuration 118 for a particular automated interaction between the IOT devices 106. The simulation may use the device capabilities accessed from the IOT database 116 for the IOT database 116 and/or the network connection therebetween. In some embodiments, the simulation may include an animation or a series of two-dimensional or three-dimensional diagrams. The simulation may be viewed on the user device 112.

During the simulation, the simulation module 204 may verify a feasibility of interactions between the IOT devices 106, confirm that the interactions do not introduce safety concerns, confirm that the interactions do not introduce privacy concerns, or any combination thereof. Additionally or alternatively, the simulation module 204 may conduct a step-by-step inspection to debug the device configuration 118 including whether the IOT devices 106 successfully communicate according to the network connection. For example, the simulation module 204 may base at least some portion of the simulation on triggering signals. The triggering signals may be configured to emulate a condition that triggers a condition to which one or more of the IOT devices 106 respond. In some embodiments, the simulation module 204 may generate and/or communicate triggering signals. In some embodiments, a user may provide the triggering signals used by the simulation module 204.

In simulations involving the triggering conditions, following input of the triggering conditions, device input 250 may be received. The device input 250 may indicate whether the device configuration 118 is operational. For instance, the simulation module 204 may compare the device input 250 to information in the IOT database 116 to determine whether the device input 250 is consistent with an expected performance of the device configuration 118. In response to the device input 250 being inconsistent with an expected performance, the simulation module 204 may deem the device configuration 118 not operational.

Based on the simulation, the determination module 202 may determine whether the device configuration 118 is operational. For example, in determining whether the device configuration 118 is operational, the determination module 202 may detect whether the runnable configuration exists and detect conflicting scenarios in the device configuration 118.

In response to the device configuration 118 not being operational, the determination module may communicate a signal to the configuration module 206. The configuration module 206 may reconfigure the device configuration 118 to include one or more replacement IOT devices (e.g., the IOT devices 106) and/or update a network connection between the replacement IOT devices. After the network connection is updated, the simulation module 204 may again simulate the device configuration 118 using the information in the IOT database 116 for the replacement IOT devices and/or network connection information.

In response to the device configuration 118 being operational, the determination module 202 may communicate a signal representative thereof to the marketplace module 210. The marketplace module 210 may be configured to display a marketplace. In some embodiments, the marketplace may be communicated to the user device 112. In other embodiments, the user device 112 may view and interact with the marketplace by accessing the configuration controller 104 and/or the system server 126.

The marketplace may provide one or more lists of IOT devices and/or virtual appliances (e.g., gateway modules and cloud services) and may enable purchase of the physical IOT devices, solution templates, the virtual appliances, or some combination thereof. Additionally or alternatively, the marketplace may interface with or provide links to one or more commercial sites on which a user may purchase the IOT devices and/or the virtual appliances.

In some embodiments, the marketplace module 210 may provide the lists of the IOT devices, solution templates, and virtual appliances prior to the configuration module 206 configuring the network connections. In some embodiments, the marketplace module 210 may provide the lists from which the IOT device selection 230 and/or the template selection 232 may be made. For example, the IOT device selection 230 may include a selection of one or more IOT devices 106 included in the lists. In these and other embodiments, the network connections may accordingly be configured to include the specific IOT devices 106 selected from a list provided by the marketplace module 210.

Additionally, in response to the device configuration 118 being operational, the determination module 202 may communicate a signal representative thereof to the deployment module 208. The deployment module 208 may be configured to deploy the device configuration 118.

In some embodiments, the deployment module 208 may be configured to communicate suggested deployment locations of the IOT devices 106 to a user via the user device 112. For example, the deployment module 208 may communicate a specific distance between the first IOT device 106A and the second IOT device 106B. Additionally or alternatively, the deployment module 208 may communicate a precise location of the first IOT device 106A such as “place the first IOT device on the ceiling of the entry hall, three feet from the front door.”

The deployment module 208 may receive the user input 234 to initiate communication of the configuration parameters 226 to the IOT devices. The user input 234 to initiate communication of the configuration parameters 226 is represented in FIG. 2 by an initiation message 254. For example, the deployment module 208 may communicate deployment locations of the IOT devices 106 to the user. The user may position the IOT devices 106 according to the deployment locations. The user may then communicate the initiation message 254 via the user device 112, which may indicate that the IOT devices 106 are deployed.

The deployment module 208 may upload the configuration parameters 226 to the IOT devices 106 and to any virtual appliances, physical hubs, gateways, etc. that may be included in the device configuration 118. The configuration parameters 226 may include information sufficient to program or otherwise configure the IOT devices 106 to operate according to the device configuration 118. The deployment module 208 may then notify the user when the configuration parameters 226 are successfully communicated to the IOT devices 106.

The deployment module 208 may then confirm the device configuration 118. The deployment module 208 may confirm the device configuration 118 using a triggering signal. In some embodiments, the triggering signal may include a user input sufficient to manually emulate a triggering condition in the device configuration 118. For example, a user may manually trigger one or more of the IOT devices 106. In response, the IOT devices 106 may communicate device input 250 to the communication module 252. The deployment module 208 may record the device input 250 resulting from the triggering condition. The deployment module 208 may then compare the device input 250 with an expected performance based on capabilities in the IOT database 116. When mismatch exists, the deployment module 208 may generate a ticket message indicating the mismatch.

The deployment module 208 may further record device input during actual usage of the device configuration 118. For example, as the device configuration 118 is used, one or more actual triggering conditions may occur. The deployment module 208 may receive the device input 250 generated from the actual triggering conditions. The device configuration 118 may then compare the device input 250 from the actual triggering conditions with an expected performance based on capabilities in the IOT database 116. When mismatch exists, the deployment module 208 may generate a ticket message indicating the mismatch and communicate the ticket message to an administrator, for example.

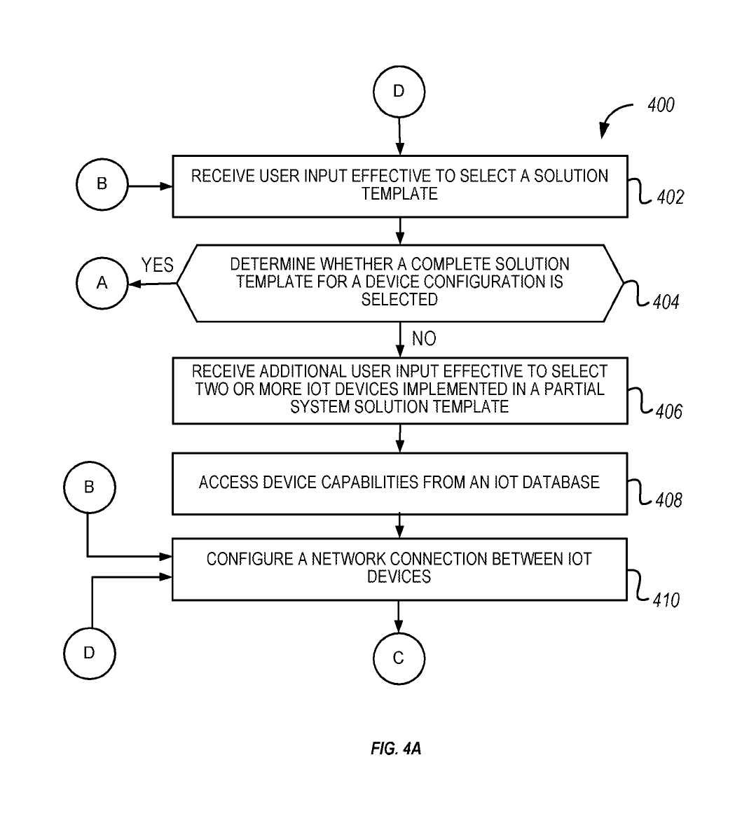

FIGS. 4A and 4B are a flow diagram of an example method 400 of constructing device configurations, arranged in accordance with at least one embodiment described herein. The method 400 may be programmably performed in some embodiments by the system server 126 described with reference to FIGS. 1 and 2. The system server 126 may include or may be communicatively coupled to one or more non-transitory computer-readable media (e.g., the memory 216 of FIG. 2) having stored thereon or encoded therein programming code or instructions that are executable by a processor to perform or cause performance of the method 400. Additionally or alternatively, the system server 126 may include one or more processors (e.g., the processor 212 of FIG. 2) that are configured to execute computer instructions to cause or control performance of the method 400. Although illustrated as discrete blocks, various blocks may be divided into additional blocks, combined into fewer blocks, or eliminated, depending on the desired implementation.

With reference to FIG. 4A, the method 400 may begin at block 402. At block 402, user input may be received. The user input may be received from a user device. The user input may be effective to select a solution template for a device configuration. The device configuration may be for a particular automated interaction between two or more IOT devices. In some embodiments, a system server may receive the user input. For example, with reference to FIG. 2, the system server 126 may receive the user input 234 from the user device 112. For example, with reference to FIG. 2, the user input 234 may include the template selection 232. The user input 234 may be received by the communication unit 214 of the system server 126.

At block 404, it may be determined whether a complete solution template for the device configuration is selected. In some embodiments, a determination module may determine whether a complete solution template for the device configuration is selected. In some embodiment, the complete solutions templates may be marked such that the determination may be made. For example, the determination module 202 may determine whether the template selection 232 includes a complete solution template. In response to a complete solution template being selected (“YES” at block 404), the method may proceed to block 420. In response to a partial solution template being selected (“NO” at block 404), the method may proceed to block 406.

At block 406, additional user input may be received. The additional user input may be effective to select two or more IOT devices implemented in the partial solution template. In some embodiments, a system server may receive the user input. For example, the communication unit 214 may receive the IOT device selection 230 communicated by the user device 112. At block 408, device capabilities may be accessed from the IOT database. In particular, the device capabilities of the selected IOT devices may be accessed. In some embodiments, a configuration module may access the device capabilities. For example, the configuration module 206 of FIG. 2 may access device capabilities from the IOT database 116 for the IOT devices 106.

At block 410, a network connection may be configured between the selected IOT devices. In some embodiments, a configuration module may configure the network connection. For example, the configuration module 206 may configure a network connection between the first IOT device 106A and the second IOT device 106B. With reference to FIG. 1, the network connection may include a portion of the network 124. In some embodiments, constructing the network connection may include a determination of whether the selected IOT devices are able to communicate with one another. In response to the selected devices being able to communicate with one another, one or more configuration parameters may be generated that enable communication between the selected IOT devices. In response to the selected devices not being able to communicate with one another, configuration parameters may be generated that enable communication between the selected IOT devices using one or more of a physical hub and a gateway module.

With reference to FIG. 4B, at block 412, a device configuration may be simulated. In some embodiments, the device configuration may be simulated using capabilities accessed from the IOT database for the IOT devices. For instance, a simulation module such as the simulation module 204 of FIG. 2 may simulate the device configuration 118 using device capabilities accessed from the IOT database 116. At block 414, it may be determined whether the device configuration is operational. For example, a determination module, such as the determination module 202, may determine whether the device configuration 118 is operational. In some embodiments, a determination of whether the device configuration is operational includes detecting whether a runnable configuration exists and detecting conflicting scenarios in the device configuration. In response to the device configuration not being operational (“NO” at 414), the method 400 may proceed to block 416. In response to the device configuration being operational (“YES” at 414), the method 400 may proceed to block 418.

At block 416, the device configuration may be reconfigured. In some embodiments, the device configuration may be reconfigured to include one or more replacement IOT devices. For example, with reference to FIG. 2, the device configuration 118 may initially include the first IOT device 106A. The determination module 202 may determine that the device configuration 118 is not operational. The configuration module 206 may then reconfigure the device configuration to include the second IOT device 106B. Following block 416, the method 400 may proceed to block 410 or block 402. For instance, when the device configuration is reconfigured to include a replacement IOT device, the method 400 may proceed to block 410. Additionally or alternatively, if the device configuration is not operational due to a larger issue, such as unsuitability for a particular circumstance, then the method 400 may proceed to block 402.

At block 418, a marketplace may be displayed. The marketplace may provide one or more lists of physical IOT devices, solution templates, virtual appliances, or some combination thereof. Additionally, the marketplace may enable purchase of the physical IOT devices and/or the virtual appliances. For example, a marketplace module such as the marketplace module 210 of FIG. 2 may be display a marketplace to the user device 112. The marketplace may include a list that includes the first IOT device 106A. The marketplace may enable the purchase of the first IOT device 106A. In some embodiments, block 418 of the method 400 may occur prior to block 402 and/or prior to block 406. For instance, a user may use the marketplace to select a solution template (as in block 402) and/or to select one or more IOT devices (as in block 406).

At block 420, the device configuration may be deployed. For example, a communication unit and a deployment module such as the communication unit 214 and the deployment module 208 of FIG. 2 may update the IOT devices 106 with the configuration parameters. At block 422, the device configuration may be confirmed. The device configuration may be confirmed using a triggering signal. For example, a deployment module such as the deployment module 208 may confirm the device configuration 118. In circumstances in which the device configuration is not confirmed, the method 400 may proceed to block 402 or to block 410. The determination of whether the method 400 proceeds to block 402 or block 410 may be based on the reason for the device configuration not being confirmed. For example, if the device configuration is not confirmed because of an unworkable solution template, then the method 400 may proceed to block 402. Additionally or alternatively, if the device configuration is not confirmed because of an unworkable network connection, the method 400 may proceed to block 410.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

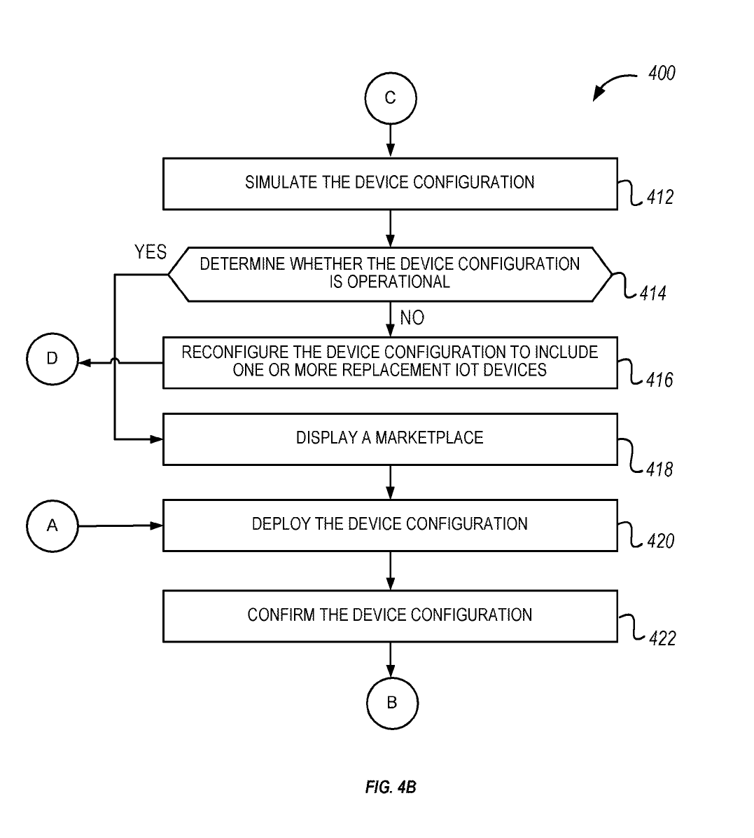

FIG. 5 is a flow diagram of an example method 500 of simulating a device configuration, arranged in accordance with at least one embodiment described herein. The method 500 may be programmably performed in some embodiments by the system server 126 described with reference to FIGS. 1 and 2. The system server 126 may include or may be communicatively coupled to one or more non-transitory computer-readable media (e.g., the memory 216 of FIG. 2) having stored thereon or encoded therein programming code or instructions that are executable by a processor to perform or cause performance of the method 500. Additionally or alternatively, the system server 126 may include one or more processors (e.g., the processor 212 of FIG. 2) that are configured to execute computer instructions to cause or control performance of the method 500. Although illustrated as discrete blocks, various blocks may be divided into additional blocks, combined into fewer blocks, or eliminated, depending on the desired implementation.

The method 500 may begin at block 502. At block 502, a feasibility of interactions between the IOT devices may be verified. For example, a simulation module such as the simulation module 204 of FIG. 2 may verify the feasibility of interactions between the first IOT device 106A and the second IOT device 106B. At block 504, it may be confirmed that the interactions do not introduce safety concerns. For example, a simulation module such as the simulation module 204 may ensure the device configuration 118 does not introduce a safety concern such as a fire, personal injury, and the like.

At block 506, it may be confirmed that the interactions do not introduce privacy concerns. For example, with reference to FIG. 2, the simulation module 204 may ensure that the device configuration 118 does not introduce a privacy concern. The privacy concern may include publishing personal information to a public site. At block 508, a step-by-step inspection may be conducted to debug the device configuration. For example, the simulation module 204 may conduct a step-by-step inspection of the device configuration 118. In some embodiments, the simulation may include one or more triggering conditions. The triggering conditions may be provided by simulation module such as the simulation module 204 of FIG. 2. Additionally or alternatively, the triggering conditions may be input by a user to an IOT device involved in the simulation. For example, the user 102 may input a triggering condition to the first IOT device 106A during a simulation of the first device configuration 118A. In simulations involving the triggering conditions, following input of the triggering conditions, device input may be received. The device input may indicate whether the device configuration is operational. For instance, the device input may be compare to information in an IOT database to determine whether the device input is consistent with an expected performance of a device configuration.

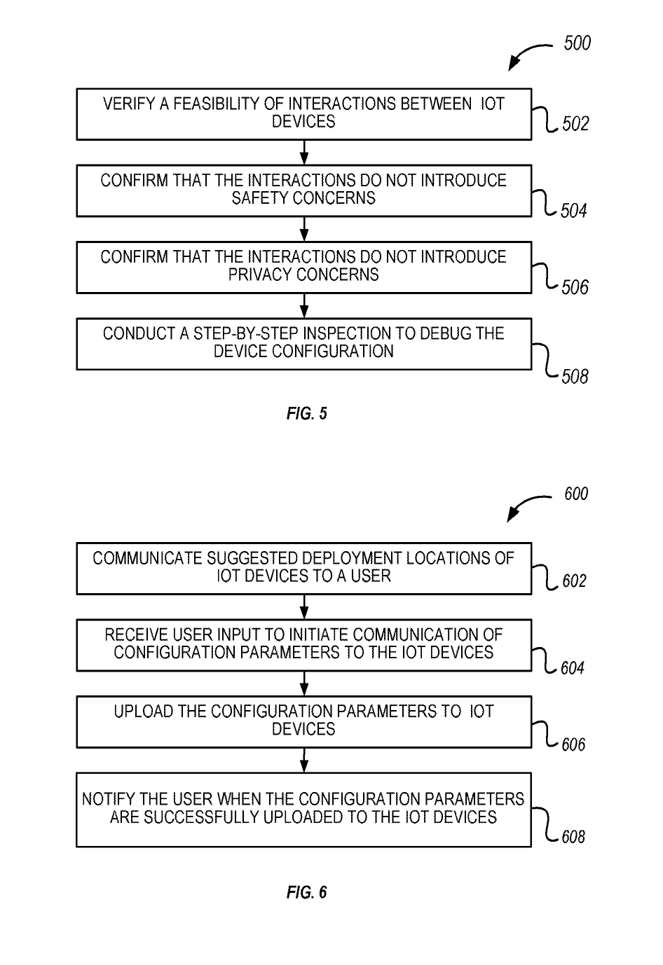

FIG. 6 is a flow diagram of an example method 600 of deploying a device configuration, arranged in accordance with at least one embodiment described herein. The method 600 may be programmably performed in some embodiments by the system server 126 described with reference to FIGS. 1 and 2. The system server 126 may include or may be communicatively coupled to one or more non-transitory computer-readable media (e.g., the memory 216 of FIG. 2) having stored thereon or encoded therein programming code or instructions that are executable by a processor to perform or cause performance of the method 600. Additionally or alternatively, the system server 126 may include one or more processors (e.g., the processor 212 of FIG. 2) that are configured to execute computer instructions to cause or control performance of the method 600. Although illustrated as discrete blocks, various blocks may be divided into additional blocks, combined into fewer blocks, or eliminated, depending on the desired implementation.

A method 600 may begin at block 602. At block 602, suggested deployment locations may be communicated. The suggested deployment locations may be for one or more IOT devices included in a device configuration. The suggested deployment locations may be communicated to a user. For example, with reference to FIG. 1, the suggested deployment locations may be communicated by the configuration controller 104 to the user device 112 via the network 124.

At block 604, user input may be received. The user input may be configured to initiate communication of configuration parameters to the IOT devices. For example, with reference to FIG. 1, the user 102 may communicate user input configured to initiate communication of the configuration parameters to the IOT devices 106. In some embodiments, the user input may be in response to the user 102 placing one or more of the IOT devices 106 in a suggested deployment location.

At block 606, the configuration parameters may be uploaded to IOT devices. For example, with reference to FIG. 1, the configuration parameters may be uploaded from the system server 126 to the IOT devices 106 via the network. The configuration parameters may also be uploaded to the cloud server 108, the gateway module 110, the physical hub 120, or some combination thereof. At block 608, the user may be notified when the configuration parameters are successfully uploaded to the IOT devices. For example, the system server 126 may notify the user 102 via the user device 112.

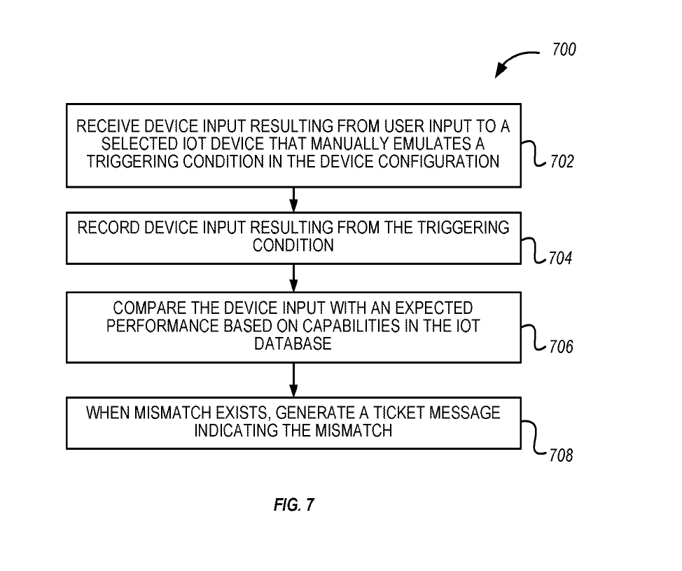

FIG. 7 is a flow diagram of an example method 700 of confirming a device configuration, arranged in accordance with at least one embodiment described herein. The method 700 may be programmably performed in some embodiments by the system server 126 described with reference to FIGS. 1 and 2. The system server 126 may include or may be communicatively coupled to one or more non-transitory computer-readable media (e.g., the memory 216 of FIG. 2) having stored thereon or encoded therein programming code or instructions that are executable by a processor to perform or cause performance of the method 700. Additionally or alternatively, the system server 126 may include one or more processors (e.g., the processor 212 of FIG. 2) that are configured to execute computer instructions to cause or control performance of the method 700. Although illustrated as discrete blocks, various blocks may be divided into additional blocks, combined into fewer blocks, or eliminated, depending on the desired implementation.

The method 700 may begin at block 702. At block 702, device input may be received. The device input may result from a user input to an IOT device that manually emulates a triggering condition in a device configuration. For example, with reference to FIG. 1, the first IOT device 106A may be included in the first device configuration 118A. The user 102 may manually emulate a triggering condition in the first IOT device 106A. In response, the first IOT device 106A may communicate device input to the system server 126.

At block 704, the device input resulting from the emulated triggering condition may be recorded. For example, with reference to FIG. 2, the deployment module 208 may record the device input 250 communicated from the first IOT device 106A. At block 706, the device input may be compared with an expected performance based on capabilities in the IOT database. For example, with reference to FIG. 2, the deployment module 208 may compare the device input 250 with an expected performance based on the capabilities of the first IOT device 106A in the IOT database 116.

At block 708, a ticket message indicating a mismatch may be generated when a mismatch exists. For example, the deployment module 208 may find a mismatch between the device input 250 from the first IOT device 106A and an expected performance of the first IOT device 106A. The expected performance of the first IOT device 106A may be at least partially based on capabilities in the IOT database 116.

The embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What we claim is:

1. A method, comprising:
receiving user input effective to select a solution template for a device configuration for a particular automated interaction between two or more Internet of Things (IOT) devices;
determining whether a complete solution template for the device configuration is selected;
in response to a partial solution template being selected:
receiving additional user input effective to select two or more IOT devices implemented in the partial solution template;
accessing device capabilities of the selected IOT devices from an IOT database;
configuring a network connection between the selected IOT devices;
simulating a device configuration using the device capabilities accessed from the IOT database for the selected IOT devices;
based on the simulation, determining whether the device configuration is operational;
in response to the device configuration not being operational, reconfiguring the device configuration to include one or more replacement IOT devices; and
in response to the device configuration being operational, deploying the device configuration; and
in response to the complete solution template being selected deploying the device configuration.

2. The method of claim 1, further comprising confirming the device configuration based on a triggering signal.

3. The method of claim 2, wherein the confirming includes:
receiving device input resulting from user input to one of the selected IOT devices that manually emulates a triggering condition in the device configuration;
recording device input resulting from the emulated triggering condition;
comparing the device input with an expected performance based at least partially on the device capabilities in the IOT database; and
when a mismatch exists, generating a ticket message indicating the mismatch.

4. The method of claim 1, wherein the configuring the network connection includes:
determining whether the selected IOT devices are able to communicate with one another;
in response to the selected devices being able to communicate, generating configuration parameters enabling communication between the selected IOT devices; and
in response to the selected devices not being able to communicate, generating parameters enabling communication between the selected IOT devices using one or more of a physical hub and a gateway module.

5. The method of claim 1, further comprising in response to the device configuration being operational, displaying a marketplace that provides a list of physical IOT devices and virtual appliances and that enables purchase of the one or more physical IOT devices and the virtual appliances.

6. The method of claim 1, wherein the simulating includes:
verifying a feasibility of interactions between the IOT devices;
confirming that the interactions do not introduce safety concerns;
confirming that the interactions do not introduce privacy concerns; and
conducting a step-by-step inspection to debug the device configuration.

7. The method of claim 1, wherein the deploying includes:
communicating suggested deployment locations of the IOT devices to a user;
receiving user input to initiate communication of configuration parameters to the IOT devices;
uploading the configuration parameters to IOT devices; and
notifying the user when the configuration parameters are successfully uploaded to the IOT devices.

8. The method of claim 1, wherein the IOT database includes:
a device capability database that stores communication protocols of one or more of the IOT devices; and
a device interoperability database that stores solutions for enabling communication between two or more of the IOT devices.

9. The method of claim 1, wherein the determining includes:
detecting whether the runnable configuration exists; and
detecting conflicting scenarios in the device configuration.

10. The method of claim 1, wherein:
the IOT devices include one or more of a lightbulb, a lighting system, a door lock, a water heater, a sprinkler system, an air-conditioner, a thermostat, an alarm clock, a window shade, a switch, a smoke alarm, a camera, an egg minder, an electrical outlet, a personal (e.g., piggy) bank, a propane tank, an alarm, a personal proximity sensor, a door sensor, a biometric sensor, a mattress, a mobile device, an automotive sensor, a clock, a cooking device, an electrical breaker, a personal alert sensor, a motion sensor, a calendar, a television, a radio, a radio frequency identification (RFID) tag/RFID detector, a vehicle, an electric vehicle charger, a distributed generator (e.g. solar panel), a distributed energy storage (e.g. battery), and a thermometer; and
the capabilities of the IOT devices include a connectivity protocol including message queue telemetry transport (MQTT), MQTT-sensor (MQTT-S), a constrained application protocol (CoAP), representative state transfer application protocol interface (REST API), and extensible messaging and presence protocol (XMPP).

11. A non-transitory computer-readable medium having encoded therein programming code executable by a processor to perform operations comprising:
receiving user input effective to select a solution template for a device configuration for a particular automated interaction between two or more Internet of Things (IOT) devices;
determining whether a complete solution template for the device configuration is selected;
in response to a partial solution template being selected:
receiving additional user input effective to select two or more IOT devices implemented in the partial solution template;
accessing device capabilities of the selected IOT devices from an IOT database;
configuring a network connection between the selected IOT devices;
simulating a device configuration using the device capabilities accessed from the IOT database for the selected IOT devices;
based on the simulation, determining whether the device configuration is operational;
in response to the device configuration not being operational, reconfiguring the device configuration to include one or more replacement IOT devices; and
in response to the device configuration being operational, deploying the device configuration; and
in response to the complete solution template being selected deploying the device configuration.

12. The non-transitory computer-readable medium of claim 11, wherein the operations further comprise confirming the device configuration based on a triggering signal.

13. The non-transitory computer-readable medium of claim 12, wherein the confirming includes:
receiving device input resulting from user input to one of the selected IOT devices that manually emulates a triggering condition in the device configuration;
recording device input resulting from the emulated triggering condition;
comparing the device input with an expected performance based at least partially on the device capabilities in the IOT database; and
when a mismatch exists, generating a ticket message indicating the mismatch.

14. The non-transitory computer-readable medium of claim 11, wherein the configuring the network connection includes:
determining whether the selected IOT devices are able to communicate with one another;
in response to the selected devices being able to communicate, generating configuration parameters enabling communication between the selected IOT devices; and
in response to the selected devices not being able to communicate, generating parameters enabling communication between the selected IOT devices using one or more of a physical hub and a gateway module.

15. The non-transitory computer-readable medium of claim 11, wherein the operations further comprise, in response to the device configuration being operational, displaying a marketplace that provides a list of physical IOT devices and virtual appliances and that enables purchase of the one or more physical IOT devices and the virtual appliances.

16. The non-transitory computer-readable medium of claim 11, wherein the simulating includes:
verifying a feasibility of interactions between the IOT devices;
confirming that the interactions do not introduce safety concerns;
confirming that the interactions do not introduce privacy concerns; and
conducting a step-by-step inspection to debug the device configuration.

17. The non-transitory computer-readable medium of claim 14, wherein the deploying includes:
communicating suggested deployment locations of the IOT devices to a user;
receiving user input to initiate communication of configuration parameters to the IOT devices;
uploading the configuration parameters to IOT devices; and
notifying the user when the configuration parameters are successfully uploaded to the IOT devices.

18. The non-transitory computer-readable medium of claim 14, wherein the IOT database includes:
a device capability database that stores communication protocols of one or more of the IOT devices; and
a device interoperability database that stores solutions for enabling communication between two or more of the IOT devices.

19. The non-transitory computer-readable medium of claim 14, wherein the determining includes:
detecting whether the runnable configuration exists; and
detecting conflicting scenarios in the device configuration.

20. The non-transitory computer-readable medium of claim 14, wherein:
the IOT devices include one or more of a lightbulb, a lighting system, a door lock, a water heater, a sprinkler system, an air-conditioner, a thermostat, an alarm clock, a window shade, a switch, a smoke alarm, a camera, an egg minder, an electrical outlet, a personal (e.g., piggy) bank, a propane tank, an alarm, a personal proximity sensor, a door sensor, a biometric sensor, a mattress, a mobile device, an automotive sensor, a clock, a cooking device, an electrical breaker, a personal alert sensor, a motion sensor, a calendar, a television, a radio, a radio frequency identification (RFID) tag/RFID detector, a vehicle, an electric vehicle charger, a distributed generator (e.g. solar panel), a distributed energy storage (e.g. battery), and a thermometer; and
the capabilities of the IOT devices include a connectivity protocol including message queue telemetry transport (MQTT), MQTT-sensor (MQTT-S), a constrained application protocol (CoAP), representative state transfer application protocol interface (REST API), and extensible messaging and presence protocol (XMPP).
